(19) United States
(12) Patent Application Publication
(10) Pub. No.: US 2024/0056906 A1
(43) Pub. Date: Feb. 15, 2024

(54) METHOD AND APPARATUS FOR SERVICE CONTINUITY

(71) Applicant: Telefonaktiebolaget LM Ericsson (publ), Stockholm (SE)

(72) Inventor: Wenliang Xu, Shanghai (CN)

(21) Appl. No.: 18/281,635

(22) PCT Filed: May 17, 2022
(86) PCT No.: PCT/CN2022/093352

§ 371 Date: Sep. 12, 2023

(30) Foreign Application Priority Data
May 18, 2021 (WO) PCT/CN2021/094377

(51) Int. Cl. H04W 36/00

(52) U.S. Cl. CPC H04W 36/0033

(57) ABSTRACT

Embodiments of the present disclosure provide method and apparatus for service continuity. A method performed by an edge enabler client comprises detecting that application context relocation (ACR) is required. The method further comprises setting an information element indicating a type of service continuity in an ACR request message. The method further comprises sending the ACR request message to an edge enabler server.

### TECHNICAL FIELD

The non-limiting and exemplary embodiments of the present disclosure generally relate to the technical field of communications, and specifically to methods and apparatuses for service continuity.

### BACKGROUND

This section introduces aspects that may facilitate a better understanding of the disclosure. Accordingly, the statements of this section are to be read in this light and are not to be understood as admissions about what is in the prior art or what is not in the prior art.

Edge computing is a network architecture concept that enables cloud computing capabilities and service environments, which are deployed close to a user equipment (UE). It promises several benefits such as lower latency, higher bandwidth, reduced backhaul traffic and prospects for new services compared to the cloud environments. 3rd Generation Partnership Project (3GPP) TS 23.558 V2.1.0, the disclosure of which is incorporated by reference herein in its entirety, provides application layer architecture and related procedures for enabling edge applications over 3GPP networks.

3GPP TS 23.558 V2.1.0 specifies the application layer architecture, procedures and information flows necessary for enabling edge applications over 3GPP networks. It includes architectural requirements for enabling edge applications, application layer architecture fulfilling the architecture requirements and procedures to enable the deployment of edge applications. One of the main focused areas is to minimize the impact to Edge based applications. So they do not need major application redevelopment for UE at the Edge.

FIG. 1 shows an example architecture for enabling edge applications. FIG. 1 is same as FIGS. 6.2-4 of 3GPP TS 23.558 V2.1.0. The Edge Data Network (EDN) is a local Data Network. Edge Application Server(s) (EAS) and the Edge Enabler Server (EES) are contained within the EDN. The Edge Configuration Server (ECS) provides configurations related to the EES (edge enabler server), including details of the Edge Data Network hosting the EES. The UE contains Application Client(s) and the Edge Enabler Client. The Edge Application Server(s), the Edge Enabler Server and the Edge Configuration Server may interact with the 3GPP Core Network.

There may be some function entities in the edge computing. For example, one or more Application Clients (ACs) may be located in a UE. One or more Edge Enabler Clients (EECs) may be located in a UE. One or more Edge Configuration Servers (ECS(s)) may be deployed to support one edge data network. One ECS may be deployed to support one or more EDN(s). One or more ECS(s) may be deployed by a PLMN (Public Land Mobile Network) operator. One or more ECS(s) may be deployed by an Edge Computing Service Provider (ECSP). One or more Edge Enabler Servers (EES(s)) may be located in an EDN. One or more EES(s) may be located in an EDN per ECSP. One or more Edge Application Servers (EAS(s)) may be located in an EDN. EAS(s) belonging to the same EAS ID (identifier) can be provided by multiple ECSP(s) in an EDN.

EDGE-1 reference point may enable interactions between the Edge Enabler Server and the Edge Enabler Client. EDGE-2 reference point enables interactions between the EES and the 3GPP Core Network functions and APIs for retrieval of network capability information. EDGE-3 reference point enables interactions between the EES and the EASs. EDGE-4 reference point enables interactions between the ECS and the EEC. EDGE-5 reference point enables interactions between AC(s) and the EEC. EDGE-6 reference point enables interactions between the ECS and the EES. EDGE-7 reference point enables interactions between the EAS and the 3GPP Core Network functions and APIs for retrieval of network capability information. EDGE-8 reference point enables interactions between the ECS and the 3GPP Core Network functions and APIs for retrieval of network capability information. EDGE-9 reference point enables interactions between two EESs.

When a UE moves to a new location, different EASs can be more suitable for serving the ACs in the UE. Such transitions can result from a non-mobility event also, requiring support from the enabling layer to maintain the continuity of the service. Alternatively, the EAS may be changed due to load balancing or O&M (Operations & Maintenance) reason.

FIG. 2 shows a high level overview of application context relocation (ACR) procedure.

At step 1. A detection entity detects that application context relocation may be required.

At step 2. A decision-making entity decides if application context relocation is needed.

At step 3. An execution entity performs application context relocation.

At step 4. All required entities may perform post application context relocation actions.

ACR can be performed for service continuity planning, which means that the first three steps of the ACR procedure, detection, decision and execution, are performed for an expected/predicted location of the UE. In such a case the T-EAS (target EAS) is to service the UE when it moves to the expected location.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Service continuity planning is an Edge Enabler Layer value-add feature of providing support for seamless service continuity, when information about planned, projected, or anticipated behavior is available at EESs or provided by EECs.

To implement the service continuity planning, an EES may utilize:
information provided by the EEC e.g., AC Schedule, Expected AC Geographical Service Area, Expected Service KPIs (Key Performance Indicators), Preferred ECSP list; and
3GPP core network capabilities utilized by EES as described in 3GPP TS 23.558 V2.1.0 clause 8.10.3.

Currently, there are five ACR scenarios specified in clause 8.8.2 of 3GPP TS 23.558 V2.1.0 (triggered by UE or EDN). For additional details on service continuity planning for ACR, see 3GPP TS 23.558 V2.1.0 clauses 8.8.2.2, 8.8.2.3, 8.8.2.4, 8.8.2.5 and 8.8.2.6.

For ACR clean-up stage, it is only executed when the UE moves to the expected location. Also, the ACT (Application Context Transfer) in a planned service continuity is different than the one in a normal service continuity. In a planned service continuity, the application context in the T-EAS (target EAS) is synchronized with up-to-date information in S-EAS (source EAS) from the time when UE has not yet moved to the predicted/expected location to the time when UE really moves to the predicted/expected location. Therefore, to use different fashion in ACT and control when to start the clean-up stage, the edge entity responsible for triggering ACT and subsequent clean-up stage needs to be synchronized with the service continuity type (i.e. normal or planned) detected by other edge entity.

In all ACR scenarios specified in clause 8.8.2 of 3GPP TS 23.558 V2.1.0:

For EEC detected, decided and executed scenario via EEC itself (scenario #1 in clause 8.8.2.2 of 3GPP TS 23.558 V2.1.0), EEC, as the detection entity, knows whether it is a planned service continuity. It's assumed that EEC can notify AC about the service continuity type via EDGE-5.

For S-EAS detected, decided and executed scenario (scenario #3 in clause 8.8.2.4 of 3GPP TS 23.558 V2.1.0), S-EAS, as the detection entity and ACT execution entity, knows whether it is a planned service continuity.

For EEC detected, decided scenario with execution via S-EES (source EES) (scenario #2 in clause 8.8.2.3 of 3GPP TS 23.558 V2.1.0), S-EAS, as the ACT execution entity, doesn't know whether it is a planned service continuity.

For EEC detected, decided scenario with execution via T-EES (target EES) (scenario #5 in clause 8.8.2.6 of 3GPP TS 23.558 V2.1.0), T-EAS, as the ACT execution entity, doesn't know whether it is a planned service continuity.

For S-EES determined and executed scenario (scenario #4 in clause 8.8.2.5 of 3GPP TS 23.558 V2.1.0):
a) If it is detected by EEC, S-EAS, as the ACT execution entity, doesn't know whether it is for a normal ACR or a planned ACR.
b) If it is detected by S-EAS, S-EAS, as the detection entity and ACT execution entity, knows whether the service continuity planning is required.
c) If it is detected by S-EES, S-EAS, as the ACT execution entity, doesn't know whether it is for a normal ACR or a planned ACR.

From above analysis, for scenario #2, #5 and #4 (a and c), there is a gap to synchronize the Service Continuity Planning information to the Edge Application Server if the Service Continuity planning detection was done by Edge Enabler Layer.

To overcome or mitigate at least one above mentioned problems or other problems, an improved service continuity management may be desirable.

In a first aspect of the disclosure, there is provided a method performed by an edge enabler client. The method comprises detecting that application context relocation (ACR) is required. The method further comprises setting an information element indicating a type of service continuity in an ACR request message. The method further comprises sending the ACR request message to an edge enabler server.

In an embodiment, the edge enabler server is a source edge enabler server.

In an embodiment, the ACR is executed by the edge enabler client via the source edge enabler server.

In an embodiment, the ACR is executed by the source edge enabler server.

In an embodiment, the edge enabler server is a target edge enabler server.

In an embodiment, the ACR is executed by the edge enabler client via the target edge enabler server.

In an embodiment, when the information element indicating the type of service continuity is set in the ACR request message, the ACR request message indicates that the ACR is triggered for service continuity planning.

In an embodiment, when the information element indicating the type of service continuity is omitted in the ACR request message, the ACR request message indicates that the ACR is triggered for normal service continuity.

In an embodiment, the type of service continuity comprises at least one of a service continuity planning or a normal service continuity.

In a second aspect of the disclosure, there is provided a method performed by an edge enabler server. The method comprises determining that application context relocation (ACR) is required. The method further comprises setting an information element indicating a type of service continuity in a notify message for the ACR. The method further comprises sending the notify message for the ACR to an edge application server.

In an embodiment, determining that application context relocation (ACR) is required comprises receiving an ACR request message comprising the information element indicating the type of service continuity from an edge enabler client and determining that the ACR is required based on the ACR request message comprising the information element indicating the type of service continuity.

In an embodiment, determining that application context relocation (ACR) is required comprises detecting that the ACR is required and determining that application context relocation (ACR) is required based on the detection.

In an embodiment, when the information element indicating the type of service continuity is set in the notify message for the ACR, the notify message for the ACR indicates that the ACR is triggered for service continuity planning.

In an embodiment, when the information element indicating the type of service continuity is omitted in the notify message for the ACR, the notify message for the ACR indicates that the ACR is triggered for normal service continuity.

In a third aspect of the disclosure, there is provided a method performed by an edge application server. The method comprises receiving a notify message for application context relocation (ACR) from an edge enabler server. The notify message for the ACR comprises an information element indicating a type of service continuity. The method further comprises determining whether the ACR has been triggered for service continuity planning based on the information element indicating the type of service continuity. The method further comprises, when the ACR has been triggered for service continuity planning and after a user equipment related to the ACR moves to an expected location, sending an ACR complete message to the edge enabler server to confirm that the ACR has completed.

In a fourth aspect of the disclosure, there is provided an edge enabler client. The edge enabler client comprises a processor and a memory coupled to the processor. Said memory contains instructions executable by said processor. Said edge enabler client is operative to detect that application context relocation (ACR) is required. Said edge enabler client is further operative to set an information element indicating a type of service continuity in an ACR request message. Said edge enabler client is further operative to send the ACR request message to an edge enabler server.

In a fifth aspect of the disclosure, there is provided an edge enabler server. The edge enabler server comprises a processor and a memory coupled to the processor. Said memory contains instructions executable by said processor. Said edge enabler server is operative to determine that application context relocation (ACR) is required. Said edge enabler server is further operative to set an information element indicating a type of service continuity in a notify message for the ACR. Said edge enabler server is further operative to send the notify message for the ACR to an edge application server.

In a sixth aspect of the disclosure, there is provided an edge application server. The edge application server comprises a processor and a memory coupled to the processor. Said memory contains instructions executable by said processor. Said edge application server is operative to receive a notify message for application context relocation (ACR) from an edge enabler server. The notify message for the ACR comprises an information element indicating a type of service continuity. Said edge application server is further operative to determine whether the ACR has been triggered for service continuity planning based on the information element indicating the type of service continuity. Said edge application server is further operative to send an ACR complete message to the edge enabler server to confirm that the ACR has completed when the ACR has been triggered for service continuity planning and after a user equipment related to the ACR moves to an expected location.

In a seventh aspect of the disclosure, there is provided an edge enabler client. The edge enabler client comprises a detecting module, a setting module and a sending module. The detecting module may be configured to detect that application context relocation (ACR) is required. The setting module may be configured to set an information element indicating a type of service continuity in an ACR request message. The sending module may be configured to send the ACR request message to an edge enabler server.

In an eighth aspect of the disclosure, there is provided an edge enabler server. The edge enabler server comprises a determining module, a setting module and a sending module. The determining module may be configured to determine that application context relocation (ACR) is required. The setting module may be configured to set an information element indicating a type of service continuity in a notify message for the ACR. The sending module may be configured to send the notify message for the ACR to an edge application server.

In a ninth aspect of the disclosure, there is provided an edge application server. The edge application server comprises a receiving module, a determining module and a sending module. The receiving module may be configured to receive a notify message for application context relocation (ACR) from an edge enabler server. The notify message for the ACR comprises an information element indicating a type of service continuity. The determining module may be configured to determine whether the ACR has been triggered for service continuity planning based on the information element indicating the type of service continuity. The sending module may be configured to send an ACR complete message to the edge enabler server to confirm that the ACR has completed when the ACR has been triggered for service continuity planning and after a user equipment related to the ACR moves to an expected location.

In a tenth aspect of the disclosure, there is provided a computer program product comprising instructions which, when executed on at least one processor, cause the at least one processor to carry out any of the methods according to the first, second and third aspects of the disclosure.

In an eleventh aspect of the disclosure, there is provided a computer-readable storage medium storing instructions which, when executed on at least one processor, cause the at least one processor to carry out any of the methods according to the first, second and third aspects of the disclosure.

Embodiments herein afford many advantages, of which a non-exhaustive list of examples follows. Some embodiments herein may solve the problem when the edge application server such as S-EAS or T-EAS doesn't have the knowledge about the ACR is for normal service continuity or service continuity planning so the edge application server such as S-EAS or T-EAS can properly send the ACR complete message at the right timing. Some embodiments herein may avoid the situation that the AC connects to the T-EAS before the UE moves to the predicted location, which lead to either non-optimal traffic routing or service interruption. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows an example architecture for enabling edge applications;

FIG. 2 shows a high level overview of application context relocation (ACR) procedure;

FIG. 3 schematically shows a high level architecture in a 4G network;

FIG. 4 schematically shows a high level architecture in the fifth generation network according to an embodiment of the present disclosure;

FIG. 5 shows a flowchart of a method according to an embodiment of the present disclosure;

FIG. 6 shows a flowchart of a method according to another embodiment of the present disclosure;

FIG. 7 shows a flowchart of a method according to another embodiment of the present disclosure;

FIG. 8a illustrates the notify operation between the EES and the EAS for continuous ACR management event notifications according to an embodiment of the present disclosure;

FIG. 8b illustrates the procedure for the EEC to execute the ACR via S-EES according to an embodiment of the present disclosure;

FIG. 9 illustrates the procedure for the S-EES to detect, decide and execute the ACR from the S-EAS to the T-EAS according to an embodiment of the present disclosure;

FIG. 10 illustrates the procedure for the EEC to execute the ACR via T-EES according to an embodiment of the present disclosure;

FIG. 11 illustrates the ACR launching procedure by the EEC according to an embodiment of the present disclosure;

FIG. 12 is a block diagram showing an apparatus suitable for practicing some embodiments of the disclosure;

FIG. 13 is a block diagram showing an edge enabler client according to an embodiment of the disclosure;

FIG. 14 is a block diagram showing an edge enabler server according to an embodiment of the disclosure; and

FIG. 15 is a block diagram showing an edge application server according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols as may comprise the first generation (1G), 2G, 3G, 4G, 4.5G, 5G communication protocols, and/or any other protocols either currently known or to be developed in the future.

The term “network function” refers to any suitable function which can be implemented in a network entity (physical or virtual) of a communication network. For example, a network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), service capability exposure function (SCEF), etc. In other embodiments, the network function may comprise different types of NFs for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies such as wireless sensor network may equally be utilized as long as exemplary embodiments described herein are applicable.

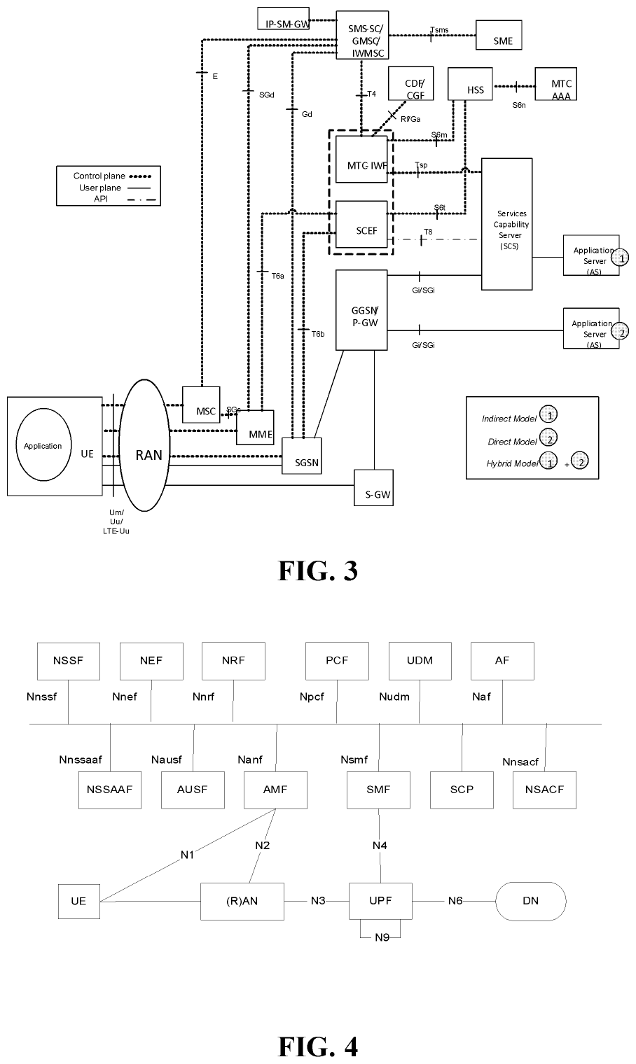

FIGS. 3-4 show some 3GPP system architectures in which the embodiments of the present disclosure can be implemented. For simplicity, the system architectures of FIGS. 3-4 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 3 schematically shows a high level architecture in a 4G network, which is same as FIG. 4.2-1a of 3GPP TS 23.682 V16.9.0, the disclosure of which is incorporated by reference herein in its entirety. The system architecture of FIG. 3 may comprise some exemplary elements such as SCS, AS, SCEF, HSS (home subscriber server), UE, RAN(Radio Access Network), SGSN (Serving GPRS (General Packet Radio Service) Support Node), MME (Mobile Management Entity), MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authentication, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 3 may be same as the corresponding network elements and interfaces as described in 3GPP TS 23.682 V16.9.0.

FIG. 4 schematically shows a high level architecture in the fifth generation network according to an embodiment of the present disclosure. For example, the fifth generation network may be 5GS. The architecture of FIG. 4 is same as FIG. 4.2.3-1 as described in 3GPP TS 23.501 V17.0.0, the disclosure of which is incorporated by reference herein in its entirety. The system architecture of FIG. 4 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 4. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 4, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 4 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 4 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.0.0.

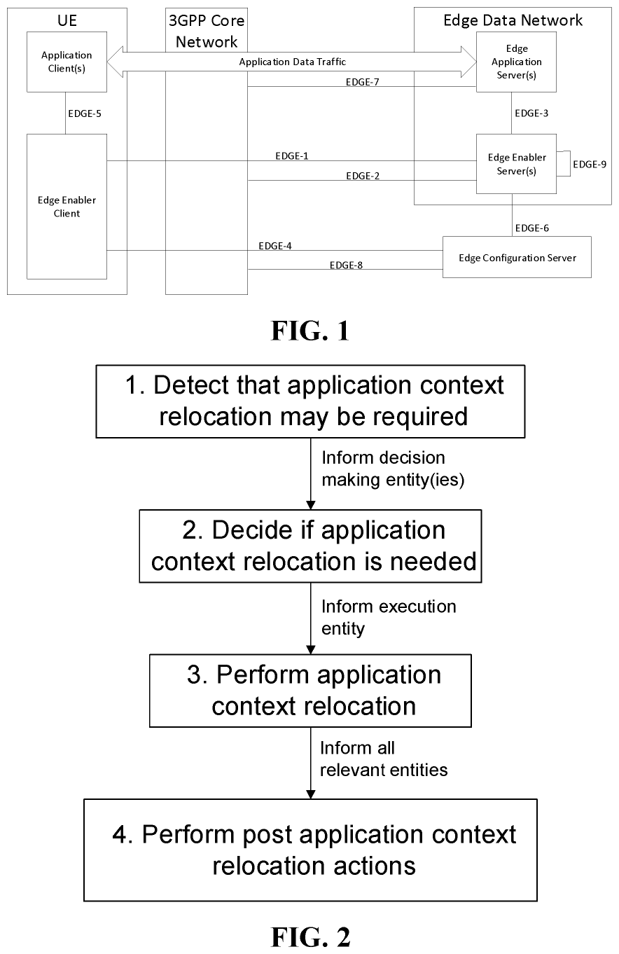

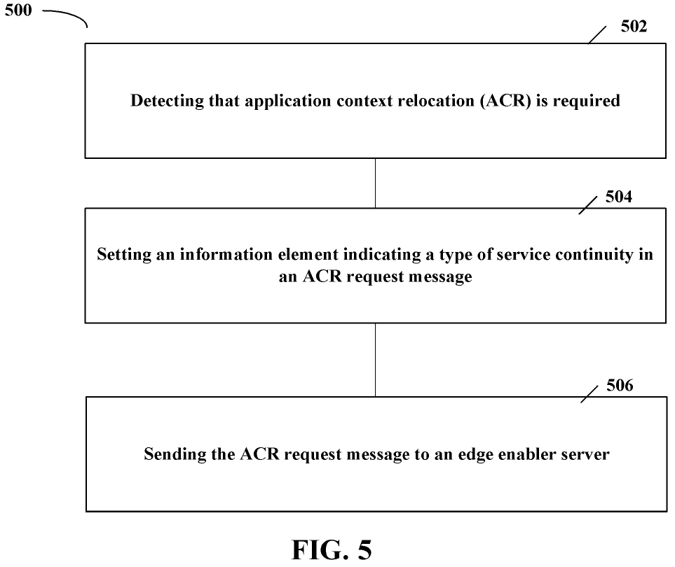

FIG. 5 shows a flowchart of a method according to an embodiment of the present disclosure, which may be performed by an apparatus implemented in or at or as an edge enabler client such as EEC of FIG. 1 or communicatively coupled to the edge enabler client. As such, the apparatus may provide means or modules for accomplishing various parts of the method 500 as well as means or modules for accomplishing other processes in conjunction with other components.

At block 502, the edge enabler client may detect that application context relocation (ACR) is required. In an embodiment, the edge enabler client detects that ACR may be required as described in clause 8.8.1 of 3GPP TS 23.558 V2.1.0. The EEC may detect that ACR may be required for an expected or predicted UE location in the future as described in clause 8.8.1 of 3GPP TS 23.558 V2.1.0.

As described in clause 8.8.1 of 3GPP TS 23.558 V2.1.0, when a UE moves to a new location, different EASs can be more suitable for serving the ACs in the UE. Such transitions can result from a non-mobility event also, requiring support from the enabling layer to maintain the continuity of the service.

The support service continuity for ACs in the UE can minimize service interruption while replacing the S-EAS with a T-EAS.

Generally, the S-EAS is associated with an application context. To support service continuity, this application context from the S-EAS is transferred to a T-EAS.

The capabilities for supporting service continuity provided at the Edge Enabler Layer may consider various application layer scenarios in which there may be involvement of AC and one or more EAS(s).

Following intra-EDN, inter-EDN and LADN (Local Area Data Network) related scenarios are supported for service continuity:
UE mobility, including predictive or expected UE mobility for the following cases:
Overload situations in S-EAS or EDN for the following cases:
Maintenance aspects such as graceful shutdown of an EAS.

To support the need of ACR, following entity roles are identified:
detection entity, detecting or predicting the need of ACR;
decision-making entity, deciding that the ACR is required; and
execution entity, executing ACR.

A detection entity detects the probable need for ACR by monitoring various aspects, such as UE's location or predicted/expected UE location and indicates to the decision-making entity to determine if the ACR is required. The AC, EEC, EES and EAS can potentially perform the detection role.

A decision-making entity determines that ACR is required and instructs the execution entity to perform ACR.

An execution entity performs ACR as and when instructed by the decision-making entity.

After a decision that another EAS is to serve the UE, the S-EAS can decide if the existing Application Context is transferred to the new EAS.

The EAS may utilize the following capabilities provided by the EES for supporting service continuity at the application layer:
Subscribe to service continuity related events and receive corresponding notifications;
Fetch the T-EAS; and
ACR from a S-EAS to a T-EAS.

The EES can utilize the following capabilities provided by the ECS for supporting service continuity at the application layer:
Fetch the T-EES.

The EEC may determine if the ACR is required by detecting that the UE moved or is predicted or expected to move outside the service area (see clause 7.3.3 of 3GPP TS 23.558 V2.1.0). The service area can be provided to the EEC by either the ECS during Service Provisioning or EES during EAS Discovery. For the PDU Session of SSC (Session and Service Continuity) mode 3, if the UE receives PDU Session Modification Command as specified in clause 4.3.5.2 of 3GPP TS 23.502 V17.0.0, the EEC may determine that the ACR is required. For IPv6 multi-homed PDU Session of SSC mode 3, the EEC may determine that ACR is required if the UE is notified of the existence and availability of a new IPv6 prefix as specified in clause 4.3.5.3 of 3GPP TS 23.502 V17.0.0.

For IPv6 (Internet protocol version 6) multi-homed PDU Session of SSC mode 3, the EEC can be aware of the notification about the IPv6 prefix configuration due to change of PSA (PDU Session Anchor) UPF based on the UE implementation.

After successful ACR:
The EES is informed of the completion by the EAS; and
The EEC is informed of the completion by the EES.

In general, a number of steps are required in order to perform the ACR procedure. The potential roles of an edge enablement layer in the ACR procedure include:
providing detection events;
selecting the T-EAS(s); and
supporting the transfer of the Application context from the S-EAS(s) to the T-EAS(s).

If the UE is connected to the 5GC (5G core network), the EES/EAS acting as AF may utilize AF traffic influence functionality from the 3GPP CN (core network) as specified in 3GPP TS 23.502 V17.0.0.

ACR can be performed for service continuity planning, which means that the ACR detection, decision and execution are performed for an expected/predicted location of the UE. In such a case the T-EAS is to service the UE when it moves to the expected location.

Service continuity planning is an Edge Enabler Layer value-add feature of providing support for seamless service continuity, when information about planned, projected, or anticipated behavior is available at EESs or provided by EECs. To implement this functionality an EES may utilize:
information provided by the EEC e.g., AC Schedule, Expected AC Geographical Service Area, Expected Service KPIs, Preferred ECSP list; and
3GPP core network capabilities utilized by EES as described in clause 8.10.3.

At block 504, the edge enabler client may set an information element indicating a type of service continuity in an ACR request message.

In an embodiment, the information element indicating the type of service continuity may be a service continuity planning indication or a normal service continuity indication.

The service continuity planning indication indicates whether the ACR request is for service continuity planning. If the service continuity planning indication is omitted in the ACR request, it implies a normal service continuity.

In an embodiment, the ACR request may be same as the ACR request as described in clause 8.8.4.4 of 3GPP TS 23.558 V2.1.0 except that it further comprises an information element indicating the type of the service continuity (normal or planning). If the information element is omitted in the ACR request, it implies a normal service continuity.

In an embodiment, the type of service continuity comprises at least one of a service continuity planning or a normal service continuity.

In an embodiment, the information element may be an service continuity planning indication or a normal service continuity indication.

In an embodiment, the information element may be a type of service continuity planning or a type of normal service continuity.

The information element indicating the type of service continuity may be any suitable information such as a bit.

At block 506, the edge enabler client may send the ACR request message to an edge enabler server.

In an embodiment, the edge enabler server is a source edge enabler server.

In an embodiment, the ACR is executed by the edge enabler client via the source edge enabler server. For example, this embodiment may be applied for the procedure for the EEC to execute the ACR via S-EES as described in clause 8.8.2.3 of 3GPP TS 23.558 V2.1.0. In the procedure for the EEC to execute the ACR via S-EES, if EEC detects that the ACR is triggered for service continuity planning, the EEC indicates it (e.g., the type of service continuity planning) in the ACR request message to the S-EES. If the ACR is triggered for service continuity planning, the S-EES indicates it (e.g., the type of service continuity planning) in the ACR Notify message to the S-EAS.

In an embodiment, the ACR is executed by the source edge enabler server. For example, this embodiment may be applied for the procedure for the S-EES to detect, decide and execute the ACR from the S-EAS to the T-EAS as described in clause 8.8.2.5 of 3GPP TS 23.558 V2.1.0. In the procedure for the S-EES to detect, decide and execute the ACR from the S-EAS to the T-EAS, if EEC detects that the ACR is triggered for service continuity planning, the EEC indicates it (e.g., the type of service continuity planning) in the ACR request message to the S-EES. If the ACR is triggered for service continuity planning, the S-EES indicates the information element indicating it (e.g., the type of service continuity planning) in the ACR Notify message to the S-EAS.

In an embodiment, the edge enabler server is a target edge enabler server.

In an embodiment, the ACR is executed by the edge enabler client via the target edge enabler server. For example, this embodiment may be applied for the procedure for the EEC to execute the ACR via T-EES as described in clause 8.8.2.6 of 3GPP TS 23.558 V2.1.0. In the procedure for the EEC to execute the ACR via T-EES, if EEC detects that the ACR is triggered for service continuity planning, the EEC indicates it (e.g., the type of service continuity planning) in the ACR request message to the T-EES. If the ACR is triggered for service continuity planning, the T-EES indicates it (e.g., the type of service continuity planning) in the ACR Notify message to the T-EAS.

In an embodiment, when the information element indicating the type of service continuity (such as a service continuity planning indication) is set in the ACR request message, the ACR request message indicates that the ACR is triggered for service continuity planning.

In an embodiment, when the information element indicating the type of service continuity is omitted in the ACR request message, the ACR request message indicates that the ACR is triggered for normal service continuity.

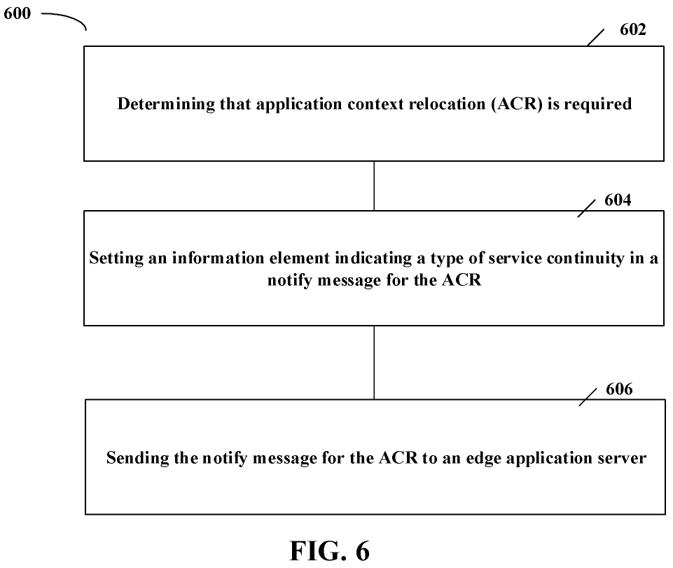

FIG. 6 shows a flowchart of a method according to another embodiment of the present disclosure, which may be performed by an apparatus implemented in or at or as an edge enabler server such as EES of FIG. 1 or communicatively coupled to the edge enabler server. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the edge enabler server may determine that application context relocation (ACR) is required.

In an embodiment, the edge enabler server may receive an ACR request message comprising the information element indicating the type of service continuity from an edge enabler client and determine that the ACR is required based on the ACR request message comprising the information element indicating the type of service continuity. For example, the edge enabler client may send the ACR request message to the edge enabler server at block 506 of FIG. 5, and then the edge enabler server may receive the ACR request message comprising the information element indicating the type of service continuity from an edge enabler client and determine that the ACR is required based on the ACR request message comprising the information element indicating the type of service continuity.

In an embodiment, the edge enabler server may detect that the ACR is required and determine that application context relocation (ACR) is required based on the detection. For example, the edge enabler server detects that ACR may be required as described in clause 8.8.1 of 3GPP TS 23.558 V2.1.0. The edge enabler server may detect that ACR may be required for an expected or predicted UE location in the future as described in clause 8.8.1 of 3GPP TS 23.558 V2.1.0.

At block 604, the edge enabler server may set an information element indicating a type of service continuity in a notify message for the ACR. In an embodiment, the information element indicating the type of service continuity may be a service continuity planning indication or a normal service continuity indication.

The service continuity planning indication indicates whether the notify message for the ACR is for service continuity planning. If the service continuity planning indication is omitted in the notify message for the ACR, it implies a normal service continuity.

At block 606, the edge enabler server may send the notify message for the ACR to an edge application server. The edge application server may be same as the EAS of FIG. 1.

In an embodiment, the notify message for the ACR may be the ACR management event notification as described in clause 8.6.3.2.3 and 8.6.3.3.4 of 3GPP TS 23.558 V2.1.0 except that it further comprises an information element indicating the type of the service continuity (normal or planning). If omitted, it implies a normal service continuity. In an embodiment, the information element of the service continuity type may be applicable for the “ACR monitoring” event or any other suitable events.

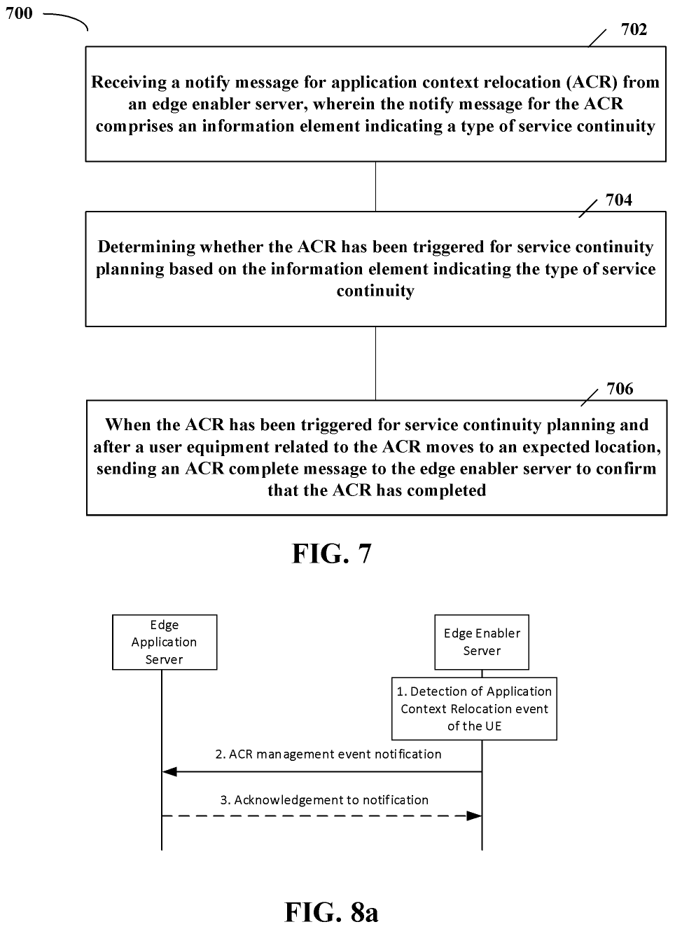

FIG. 7 shows a flowchart of a method according to another embodiment of the present disclosure, which may be performed by an apparatus implemented in or at or as an edge application server such as EAS of FIG. 1 or communicatively coupled to the edge application server. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the edge application server may receive a notify message for application context relocation (ACR) from an edge enabler server. The notify message for the ACR comprises an information element indicating a type of service continuity. For example, the edge enabler server may send the notify message for the ACR to the edge application server at block 606 of FIG. 6, and then the edge application server may receive a notify message for application context relocation (ACR) from the edge enabler server.

At block 704, the edge application server may determine whether the ACR has been triggered for service continuity planning based on the information element indicating the type of service continuity. For example, when the information element indicates the type of service continuity planning, the edge application server may determine that the ACR has been triggered for service continuity planning. When the information element indicates the type of normal service continuity or is omitted, the edge application server may determine that the ACR has been triggered for normal service continuity.

For the handling in EAS (such as T-EAS or S-EAS) after receiving the ACR notify message including an information element indicating a type of service continuity planning, the EAS shall start UE location monitoring (if not started before). The S-EAS shall ensure the application context in the T-EAS is synchronized with up-to-date information in S-EAS from the time when UE has not yet moved to the predicted/expected location to the time when UE really moves to the predicted/expected location.

At block 706, when the ACR has been triggered for service continuity planning and after a user equipment related to the ACR moves to an expected location, the edge application server may send an ACR complete message to the edge enabler server to confirm that the ACR has completed.

In an embodiment, Table 8.6.3.3.4-1 of 3GPP TS 23.558 V2.1.0 may be amended as following table 1. Table 8.6.3.3.4-1 describes the information elements for an ACR management event notification from the EES to the EAS.

TABLE 1
ACR management event notification

| Information element | Status | Description |
|---|---|---|
| Subscription ID | M | Subscription identifier corresponding to the |
| | | subscription stored in the EES for the request |
| List of event notifications | M | A list of event notifications for one or more UEs. |
| >Event report | M | Event reporting information as specified in |
| | | clause 5.2.8.3.1 of 3GPP TS 23.502 [3] |
| >Timestamp | O | The timestamp of each event report. |
| >T-EAS endpoint | O | The T-EAS endpoint. This information shall be |
| | | included for the “ACR monitoring” event and “ACR |
| | | facilitation” event. |
| >Service continuity type | O | Indicates the type of the service continuity (normal |
| | | or planning). If omitted, it implies a normal service |
| | | continuity. Applicable for the “ACR monitoring” |
| | | event. |

In another embodiment, Table 8.6.3.3.4-1 of 3GPP TS 23.558 V2.1.0 may be amended as following table 2.

TABLE 8.6.3.3.4-1
ACR management event notification

| Information element | Status | Description |
|---|---|---|
| Subscription ID | M | Subscription identifier corresponding to the |
| | | subscription stored in the EES for the request |
| List of event notifications | M | A list of event notifications for one or more UEs. |
| >Event report | M | Event reporting information as specified in |
| | | clause 5.2.8.3.1 of 3GPP TS 23.502 [3] |
| >Timestamp | O | The timestamp of each event report. |
| >T-EAS endpoint | O | The T-EAS endpoint. This information shall be |
| | | included for the “ACR monitoring” event and “ACR |
| | | facilitation” event. |
| >Service Continuity Planning | O | Indicates whether the notification is for service |
| indication | | continuity planning. If omitted, it implies a normal |
| | | service continuity. Applicable for the “ACR |
| | | monitoring” event. |

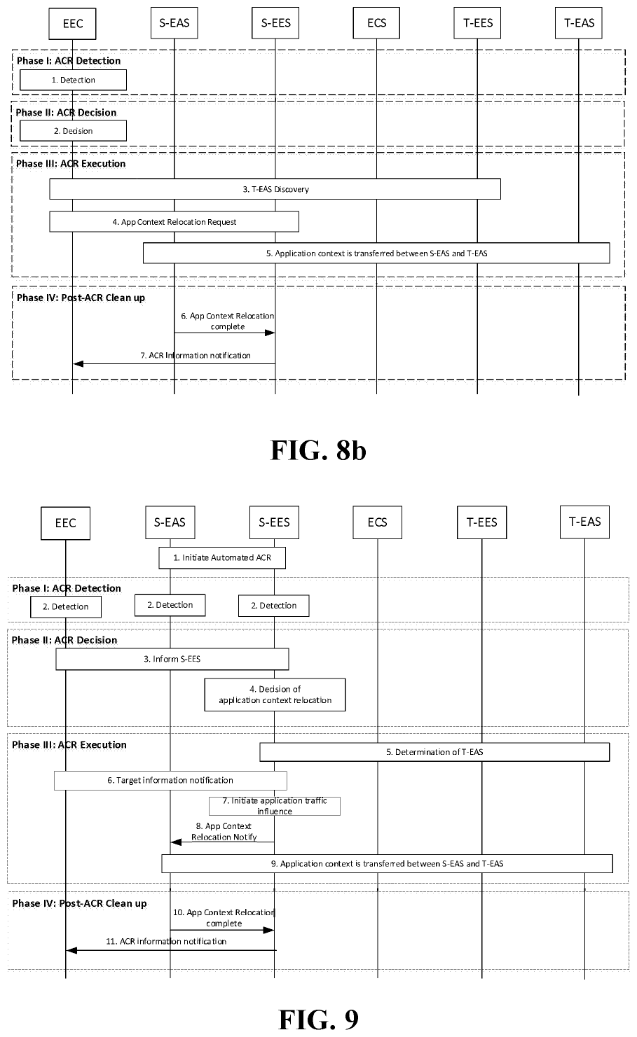

FIG. 8a illustrates the notify operation between the EES and the EAS for continuous ACR management event notifications according to an embodiment of the present disclosure. FIG. 8a is same as FIG. 8.6.3.2.3-1 of 3GPP TS 23.558 V2.1.0.

At step 1 of FIG. 8a. The EES detects the ACR management event of the UE (e.g. receiving User plane path management event notification for the UE from the 3GPP core network). In an embodiment, the EES may determine that application context relocation (ACR) is required. For example, the edge enabler server may receive an ACR request message comprising the information element indicating the type of service continuity from an edge enabler client and determine that the ACR is required based on the ACR request message comprising the information element indicating the type of service continuity. As another example, the EES detects that ACR may be required as described in clause 8.8.1 of 3GPP TS 23.558 V2.1.0. The edge enabler server may detect that ACR may be required for an expected or predicted UE location in the future as described in clause 8.8.1 of 3GPP TS 23.558 V2.1.0.
a. If “user plane path change” Event is subscribed, the EES may cache the detected User plane path management event notification locally with timestamp as the latest information of the UE(s) and start the notification aggregation for a group of UEs. The EES decides whether to aggregate and the aggregation period based on the analytics result received from the 3GPP Core Network, local policy and User Plane path management subscription information received from the EAS. The EES determines to notify the user plane path management event notification information (e.g., DNAI) to the EASs which has subscribed for the “user plane path management” event.
b. If “ACR monitoring” Event is subscribed, based on the detected user plane path change report sent from the 3GPP core network, the EES checks whether the target DNAI is in the EAS profile of the subscribing EAS, if not it further checks whether a T-EAS is available at the target DNAI as described in steps 2-4 of clause 8.8.3.2 of 3GPP TS 23.558 V2.1.0.
c. If “ACR facilitation” Event is subscribed, based on the detected user plane path change report sent from the 3GPP core network, the EES checks whether the target DNAI is in the EAS profile of the subscribing EAS, if not it further checks whether a T-EAS is available at the target DNAI as described in steps 2-4 of clause 8.8.3.2 of 3GPP TS 23.558 V2.1.0. If a T-EAS is available, the EES selects the T-EAS from the discovered EAS list and applies the AF traffic influence with the N6 routing information of the selected T-EAS in the 3GPP Core Network. The EES also notifies the S-EAS with the selected T-EAS endpoint.

At step 2 of FIG. 8a. The EES sends ACR management event notification to the EAS. The EES includes the ACR management event notification information of the UE(s) and optionally the timestamp. If the event triggering the notification is DNAI change, the timestamp can be included to indicate the age of the user plane path management event notification information. The EES may only provide part of information included in the user plane path management event notification from 3GPP network (e.g. target DNAI). If the EAS had provided “Indication of EAS acknowledgement”, the EES waits for acknowledgement from the EAS before it sends AF acknowledgement to the 3GPP core network. If a T-EAS is available, the EES notifies the EAS with T-EAS endpoint; otherwise this event notification will not be sent. In an embodiment, if the ACR is triggered for service continuity planning, the EES indicates it in the ACR management event notification to the EAS. In another embodiment, if the ACR is triggered for service continuity planning, the EES sets the service continuity planning indication in the ACR management event notification to the EAS.

At step 3 of FIG. 8a. If the EAS had included Indication of EAS Acknowledgement within ACR path management event subscribe request described in clause 8.6.3.2.1 of 3GPP TS 23.558 V2.1.0, the EAS sends EAS Acknowledgement as a response to ACR management event notification to the EES either immediately or after the required ACT is completed. The EAS may reply in negative, e.g., the EAS may determine not to perform ACR. Then, the EES sends the AF acknowledgement to the 3GPP core network.

FIG. 8b illustrates the procedure for the EEC to execute the ACR via S-EES according to an embodiment of the present disclosure. FIG. 8b is same as FIG. 8.8.2.3-1 of 3GPP TS 23.558 V2.1.0.

Pre-Condition:
1. The AC at the UE already has a connection to the S-EAS; and
2. The EEC is able to communicate with the S-EES.

Phase I: ACR Detection

At step 1 of FIG. 8b. The EEC detects that ACR may be required as described in clause 8.8.1 of 3GPP TS 23.558 V2.1.0. The EEC may detect that ACR may be required for an expected or predicted UE location in the future as described in clause 8.8.1 of 3GPP TS 23.558 V2.1.0.

Phase II: ACR Decision

At step 2 of FIG. 8b. The EEC decides to proceed required procedures for triggering ACR.

Phase III: ACR Execution

At step 3 of FIG. 8b. The EEC determines the T-EES by using the provisioned information or performing service provisioning procedure per clause 8.3 of 3GPP TS 23.558 V2.1.0. When in step 1 of FIG. 8b the ACR for service continuity planning is triggered, then the Connectivity information and UE Location in the Service Provisioning (as specified in clause 8.3) procedure contains the expected Connectivity information and expected UE Location. If the UE is within the service area of the T-EES, upon selecting T-EES the UE may need to establish a new PDU connection to the target EDN. The EEC can then discover and select T-EAS by performing EAS Discovery with the T-EES per clause 8.5.2 of 3GPP TS 23.558 V2.1.0.

At step 4 of FIG. 8b. The EEC performs ACR launching procedure (as described in 8.8.3.4 of 3GPP TS 23.558 V2.1.0) to the S-EES with the ACR action indicating ACR initiation and the corresponding ACR initiation data (with the need to notify the EAS). In an embodiment, if the ACR is triggered for service continuity planning in step 1 of FIG. 8b, the EEC indicates it in the ACR request message to the S-EES. In another embodiment, if the ACR is triggered for service continuity planning in step 1, the EEC sets the service continuity planning indication in the ACR request message to the S-EES. The S-EES authorizes the request from the EEC. The S-EES decides to execute ACR based on the information received from the EEC, EEC context and/or EAS profile, The S-EES may apply the AF traffic influence with the N6 routing information of the T-EAS in the 3GPP Core Network (if applicable) and sends the ACR Notify message to the S-EAS to initiate ACT between the S-EAS and the T-EAS. In an embodiment, if the ACR is triggered for service continuity planning, the S-EES indicates it in the ACR Notify message to the S-EAS. In another embodiment, if the ACR is triggered for service continuity planning, the S-EES sets the service continuity planning indication in the ACR Notify message to the S-EAS. The EEC also subscribes to receive ACR information notifications for ACR complete events from the S-EES, as described in clause 8.8.3.5.2 of 3GPP TS 23.558 V2.1.0.

At step 5 of FIG. 8b. The S-EAS transfers the application context to the T-EAS at implementation specific time.

Phase IV: Post-ACR Clean up

When in step 1 of FIG. 8b the ACR has been triggered for service continuity planning, if the UE does not move to the predicted location, the EEC does not connect to T-EES, the AC does not connect to the T-EAS. Steps 6 and 7 of FIG. 8b are skipped.

NOTE: When in step 1 of FIG. 8b the ACR for service continuity planning is triggered, steps 6 and 7 of FIG. 8b are performed after the UE moves to the predicted location.

At step 6 of FIG. 8b. The S-EAS sends the ACR Complete message to the S-EES to confirm that the ACR has completed.

At step 7 of FIG. 8b. The S-EES sends the ACR information notification message to the EEC to confirm that the ACR has completed as specified in clause 8.8.3.5.3 of 3GPP TS 23.558 V2.1.0.

FIG. 9 illustrates the procedure for the S-EES to detect, decide and execute the ACR from the S-EAS to the T-EAS according to an embodiment of the present disclosure. FIG. 9 is same as FIG. 8.8.2.5-1 of 3GPP TS 23.558 V2.1.0.

This procedure of FIG. 9 may support automated ACR by S-EES when initiated by S-EAS as per clause 8.8.3.6 of 3GPP TS 23.558 V2.1.0.

Pre-Condition:
1. The AC at the UE already has a connection to the S-EAS;
2. The EEC is able to communicate with the S-EES; and
3. The EEC has subscribed to receive ACR information notifications for target information notification events and ACR complete events from the S-EES, as described in clause 8.8.3.5.2 of 3GPP TS 23.558 V2.1.0.

At step 1 of FIG. 9. The S-EAS may initiate Automated ACR with S-EES as specified in clause 8.8.3.6 of 3GPP TS 23.558 V2.1.0. In this step, the S-EAS and S-EES negotiate an address of the Application Context storage to S-EES. The S-EAS puts the Application Context at this address which can be further accessed by the S-EES when the ACT is required.

In this case, the S-EES executes steps 2 (i.e., S-EES detection), 4, 5, 6, 7, 8, 9 and 11 of FIG. 9. Rest of steps of FIG. 9 are skipped.

Phase I: ACR Detection

At step 2 of FIG. 9. Detection entities (S-EAS, S-EES, EEC) detects that ACR may be required as described in clause 8.8.1 of 3GPP TS 23.558 V2.1.0. The detection by the S-EES may be triggered by the User Plane path change notification received from the 3GPP Core Network due to S-EAS request for “ACR facilitation” event (see clause 8.6.3 of 3GPP TS 23.558 V2.1.0).

The detection entity may detect that ACR may be required for an expected or predicted UE location in the future as described in clause 8.8.1 of 3GPP TS 23.558 V2.1.0. At step 3 of FIG. 9. The detection entity performs ACR launching procedure (as

described in 8.8.3.4 of 3GPP TS 23.558 V2.1.0) with the ACR action indicating ACR determination and the corresponding ACR determination data. In an embodiment, if the ACR is triggered for service continuity planning in step 2 of FIG. 9, the EEC indicates it in the ACR request message to the S-EES. In another embodiment, if the ACR is triggered for service continuity planning in step 2, the EEC sets the service continuity planning indication in the ACR request message to the S-EES.

Phase II: ACR Decision

At step 4 of FIG. 9. The S-EES authorizes the message if received. The S-EES decides to execute ACR based on the information received or local detection, and the information of EEC context or EAS profile, and then proceed the below steps of FIG. 9.

Phase III: ACR Execution

At step 5 of FIG. 9. The S-EES determines T-EES and T-EAS via the Discover T-EAS procedure in clause 8.8.3.2 of the present document. When in step 2 of FIG. 9 the ACR has been triggered for service continuity planning, then UE Location and Target DNAI values provided in the Retrieve T-EES procedure contain the expected UE Location and expected Target DNAI. The S-EES may decide not to perform ACR if T-EAS is not available.

At step 6 of FIG. 9. The S-EES sends the target information notification to the EEC as described in clause 8.8.3.5.3 of 3GPP TS 23.558 V2.1.0.

At step 7 of FIG. 9. The S-EES may apply the AF traffic influence with the N6 routing information of the T-EAS in the 3GPP Core Network (if applicable).

At step 8 of FIG. 9. The S-EES sends the ACR Notify message (e.g. as notification for “ACR facilitation” event) to the S-EAS to initiate ACT between the S-EAS and the T-EAS. In an embodiment, if the ACR is triggered for service continuity planning, the S-EES indicates it in the ACR Notify message to the S-EAS. In another embodiment, if the ACR is triggered for service continuity planning, the S-EES sets the service continuity planning indication in the ACR Notify message to the S-EAS.

At step 9 of FIG. 9. The Application Context is transferred from S-EAS to the T-EAS at implementation specific time. In the case of automated ACR, the S-EES accesses the Application Context from the address as per step 1 of FIG. 9 and the S-EES and T-EES engage in the ACT from S-EAS to the T-EAS (obtained as per step 5 of FIG. 9) in a secure way. Further the T-EAS accesses the Application Context made available by the T-EES. S-EAS may perform the ACT directly with T-EAS.

The Application Context is encrypted and protected by the application layer. The S-EES and the T-EES engage in the packet level transport of the Application Context and they have no visibility to the content of the Application Context.

Phase IV: Post-ACR Clean up

When in step 2 of FIG. 9 the ACR has been triggered for service continuity planning, if the UE does not move to the predicted location, the EEC does not connect to T-EES, the AC does not connect to the T-EAS. Steps 10 and 11 of FIG. 9 are skipped.

When in step 2 of FIG. 9 the ACR has been triggered for service continuity planning, steps 10 and 11 of FIG. 9 would only be performed after the UE moves to the expected location.

At step 10 of FIG. 9. The S-EAS sends the ACR Complete message to the S-EES to confirm that the ACR has completed.

At step 11 of FIG. 9. The S-EES sends the ACR information notification message to the EEC to confirm that the ACR has completed as specified in clause 8.8.3.5.3 of 3GPP TS 23.558 V2.1.0.

The Application Client mechanism may support switchover of the application traffic to T-EAS.

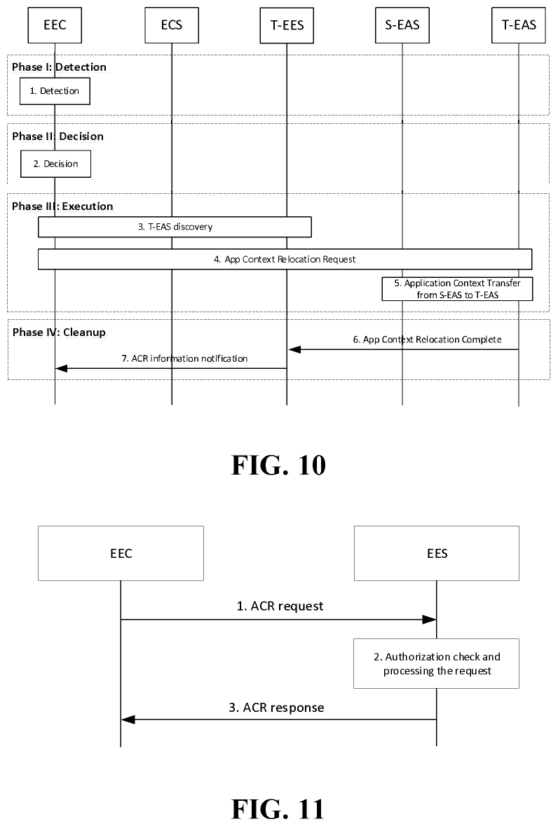

FIG. 10 illustrates the procedure for the EEC to execute the ACR via T-EES according to an embodiment of the present disclosure. FIG. 10 is same as FIG. 8.8.2.6-1 of 3GPP TS 23.558 V2.1.0.

Pre-Condition:
1. The EEC has the S-EAS information that serves the AC.

Phase I: ACR Detection

At step 1 of FIG. 10. The EEC detects that ACR may be required as described in clause 8.8.1 of 3GPP TS 23.558 V2.1.0. The EEC may detect that ACR may be required for an expected or predicted UE location in the future as described in clause 8.8.1 of 3GPP TS 23.558 V2.1.0.

Phase II: ACR Decision

At step 2 of FIG. 10. The EEC decides to proceed with required procedures for ACR.

If supported, the AC can be involved in the decision.

Phase III: ACR Execution

At step 3 of FIG. 10. The EEC determines the T-EES by using the provisioned information or performing service provisioning procedure per clause 8.3 of 3GPP TS 23.558 V2.1.0. When in step 1 of FIG. 10 the ACR for service continuity planning is triggered, then the Connectivity information and UE Location used in the service provisioning procedure contain the expected Connectivity information and expected UE Location. If the UE is within the service area of the T-EES, upon selecting the T-EES the UE may need to establish a new PDU connection to the target EDN. The EEC performs EAS Discovery with the T-EES per clause 8.5.2 of 3GPP TS 23.558 V2.1.0.

At step 4 of FIG. 10. The EEC performs ACR launching procedure (as described in 8.8.3.4 of 3GPP TS 23.558 V2.1.0) to the T-EES with the ACR action indicating ACR initiation and the corresponding ACR initiation data (with the need to notify the EAS). In an embodiment, if the ACR is triggered for service continuity planning in step 1 of FIG. 10, the EEC indicates it in the ACR request message to the T-EES. In another embodiment, if the ACR is triggered for service continuity planning in step 1, the EEC sets the service continuity planning indication in the ACR request message to the T-EES. The T-EES may apply the AF traffic influence with the N6 routing information of the T-EAS in the 3GPP Core Network (if applicable). Then the T-EES sends the ACR Notify message to the T-EAS. The EEC also subscribes to receive ACR information notifications for ACR complete events from the T-EES, as described in clause 8.8.3.5.2 of 3GPP TS 23.558 V2.1.0. In an embodiment, if the ACR is triggered for service continuity planning, the T-EES indicates it in the ACR Notify message to the T-EAS. In another embodiment, if the ACR is triggered for service continuity planning, the T-EES sets the service continuity planning indication in the ACR Notify message to the T-EAS.

At step 5 of FIG. 10. The T-EAS initiates ACT between the S-EAS and the T-EAS.

Phase IV: Post-ACR clean up

When in step 1 of FIG. 10 the ACR has been triggered for service continuity planning, if the UE does not move to the predicted location the EEC does not connect to T-EES, the AC does not connect to the T-EAS. Steps 6 and 7 of FIG. 10 are skipped.

NOTE 2: When in step 1 of FIG. 10 the ACR has been triggered for service continuity planning, steps 6 and 7 of FIG. 10 would only be performed after the UE moves to the expected location.

At step 6 of FIG. 10. The T-EAS sends the ACR Complete message to the T-EES to confirm that the ACR has completed.

At step 7 of FIG. 10. The T-EES sends the ACR information notification message to the EEC as described in clause 8.8.3.5.3 of 3GPP TS 23.558 V2.1.0.

If the procedure fails after step 4 of FIG. 10, it will be terminated with an appropriate cause in the ACR Response message to the EEC in step 7 of FIG. 10. The EEC may then proceed attempting to obtain services from the T-EAS discovered in step 3 of FIG. 10 without service continuity support. Alternatively, the EEC may resume the present procedure starting with step 3 of FIG. 10 and selecting a different T-EES.

The support of ACR between EDNs operated by different ECSPs is dependent on business agreement between the ECSPs.

FIG. 11 illustrates the ACR launching procedure by the EEC according to an embodiment of the present disclosure. FIG. 11 is same as FIG. 8.8.3.4-1 of 3GPP TS 23.558 V2.1.0.

Depending on the ACR action indicated in the ACR request, the procedure is used for either ACR initiation or ACR determination.

Pre-Condition:
1. The EEC has been authorized to communicate with the EES as specified in clause 8.11.

At step 1 of FIG. 11. The EEC sends an ACR request message to the EES in order to start ACR. The ACR request message includes ACR action to indicate either ACR initiation request or ACR determination request. In an embodiment, the ACR request message may include service continuity type to indicate whether the launching procedure is for service continuity planning. In another embodiment, if the EEC requires service continuity planning, it also sets the service continuity planning indication in the ACR request message.

An ACR request for ACR initiation:
includes an indication of whether the EEC requests the EES to perform EAS notification; and
provides information used by EES to perform AF traffic influence as in 3GPP TS 23.501[2].

An ACR request for ACR determination informs the EES that the need for ACR has been detected at EEC.

At step 2 of FIG. 11. The EES checks if the EEC is authorized for this operation. If authorized, the EES processes the request and performs the required operations.

If the request in step 1 is for ACR initiation:
the EES may use information provided in the request to apply the AF traffic influence with the N6 routing information of the T-EAS in the 3GPP Core Network (if applicable), as described in 3GPP TS 23.501 V17.0.0, clause 5.6.7.1; and
if the EAS notification indication is provided in the step 1 request and the EAS has subscribed to receive such notification, the EES shall notify the EAS about the need to start ACR.

If the request in step 1 is for ACR determination, the EES decides to execute ACR as described in clause 8.8.2.5 of 3GPP TS 23.558 V2.1.0.

At step 3 of FIG. 11. The EES responds to the EEC's request with an ACR response message.

In an embodiment, Table 8.8.4.4-1 of 3GPP TS 23.558 V2.1.0 may be amended as following table 3. Table 8.8.4.4-1 describes information elements for the ACR request sent from the EEC either to the S-EES or T-EES.

TABLE 3
ACR request

| Information element | Status | Description |
|---|---|---|
| EECID | M | Unique identifier of the EEC. |
| Security credentials | M | Security credentials resulting from a successful |
| | | authorization for the edge computing service. |
| UE identifier | M | The identifier of the UE (i.e. GPSI). |
| ACR action | M | Indicates the ACR action (ACR initiation or ACR |
| | | determination) |
| Service continuity type | O | Indicates the type of the service continuity (normal |
| | | or planning). If omitted, it implies a normal service |
| | | continuity. |
| ACR initiation data (NOTE 2) | O | ACR initiation IEs to be included in an ACR request |
| | | message when ACR action indicates it is ACR |
| | | initiation request. |
| >T-EAS Endpoint | M | Endpoint information (e.g. URI, FQDN, IP 3-tuple) of |
| | | the T-EAS. |
| >DNAI of the T-EAS | O | DNAI information associated with the T-EAS. |
| >N6 Traffic Routing | O | The N6 traffic routing information and/or routing |
| requirements | | profile ID corresponding to the T-EAS DNAI. |
| >EAS notification indication | M | Indicates whether to notify the EAS about the need |
| | | of ACR. |
| >S-EAS endpoint (NOTE 1) | O | Endpoint information of the S-EAS |
| ACR determination data (NOTE 2) | O | ACR determination IEs to be included in an ACR |
| | | request message when ACR action indicates it is |
| | | ACR determination request. |
| >S-EAS endpoint | M | Endpoint information of the S-EAS |

NOTE 1:
This IE shall be present if the EAS notification indication indicates that the EAS needs to be informed.
NOTE 2:
Either ACR initiation or ACR determination shall be included corresponding to the ACR action.

In another embodiment, Table 8.8.4.4-1 of 3GPP TS 23.558 V2.1.0 may be amended as following table 4.

TABLE 4
ACR request

| Information element | Status | Description |
|---|---|---|
| EECID | M | Unique identifier of the EEC. |
| Security credentials | M | Security credentials resulting from a successful |
| | | authorization for the edge computing service. |
| UE identifier | M | The identifier of the UE (i.e. GPSI). |
| ACR action | M | Indicates the ACR action (ACR initiation or ACR |
| | | determination) |
| Service Continuity Planning | O | Indicates whether the request is for service |
| indication | | continuity planning. If omitted, it implies a normal |
| | | service continuity. |
| ACR initiation data (NOTE 2) | O | ACR initiation IEs to be included in an ACR request |
| | | message when ACR action indicates it is ACR |
| | | initiation request. |
| >T-EAS Endpoint | M | Endpoint information (e.g. URI, FQDN, IP 3-tuple) of |
| | | the T-EAS. |
| >DNAI of the T-EAS | O | DNAI information associated with the T-EAS. |
| >N6 Traffic Routing | O | The N6 traffic routing information and/or routing |
| requirements | | profile ID corresponding to the T-EAS DNAI. |
| >EAS notification indication | M | Indicates whether to notify the EAS about the need |
| | | of ACR. |
| >S-EAS endpoint (NOTE 1) | O | Endpoint information of the S-EAS |
| ACR determination data (NOTE 2) | O | ACR determination IEs to be included in an ACR |
| | | request message when ACR action indicates it is |
| | | ACR determination request. |
| >S-EAS endpoint | M | Endpoint information of the S-EAS |

NOTE 1:
This IE shall be present if the EAS notification indication indicates that the EAS needs to be informed.
NOTE 2:
Either ACR initiation or ACR determination shall be included corresponding to the ACR action.

The various blocks/steps shown in FIGS. 5-11 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Embodiments herein afford many advantages, of which a non-exhaustive list of examples follows. Some embodiments herein may solve the problem when the edge application server such as S-EAS or T-EAS doesn't have the knowledge about the ACR is for normal service continuity or service continuity planning so the edge application server such as S-EAS or T-EAS can properly send the ACR complete message at the right timing. Some embodiments herein may avoid the situation that the AC connects to the T-EAS before the UE moves to the predicted location, which lead to either non-optimal traffic routing or service interruption. The embodiments herein are not limited to the features and advantages mentioned above. A person skilled in the art will recognize additional features and advantages upon reading the following detailed description.

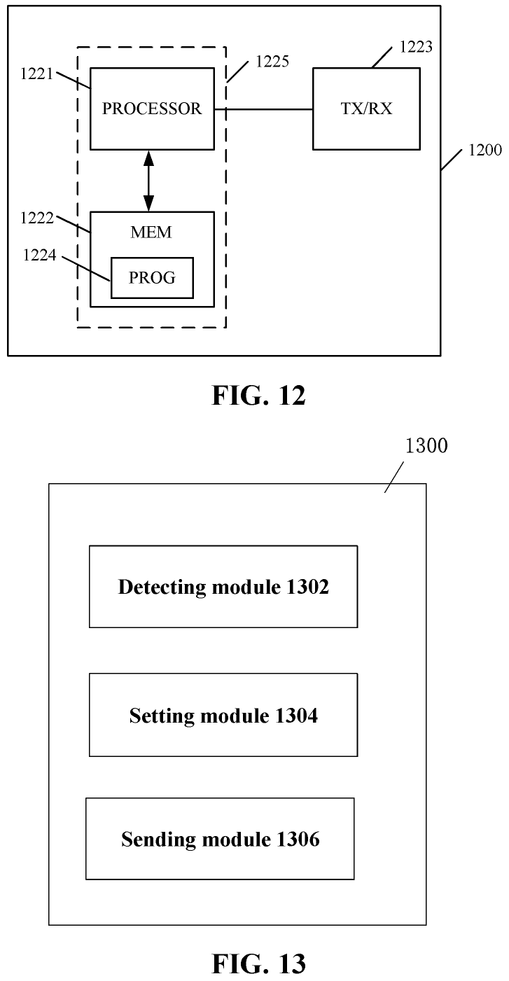

FIG. 12 is a block diagram showing an apparatus suitable for practicing some embodiments of the disclosure. For example, any one of the edge enabler client, the edge enabler server and the edge application server described above may be implemented as or through the apparatus 1200.

The apparatus 1200 comprises at least one processor 1221, such as a digital processor (DP), and at least one memory (MEM) 1222 coupled to the processor 1221. The apparatus 1220 may further comprise a transmitter TX and receiver RX 1223 coupled to the processor 1221. The MEM 1222 stores a program (PROG) 1224. The PROG 1224 may include instructions that, when executed on the associated processor 1221, enable the apparatus 1220 to operate in accordance with the embodiments of the present disclosure. A combination of the at least one processor 1221 and the at least one MEM 1222 may form processing means 1225 adapted to implement various embodiments of the present disclosure.

Various embodiments of the present disclosure may be implemented by computer program executable by one or more of the processor 1221, software, firmware, hardware or in a combination thereof.

The MEM 1222 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 1221 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the edge enabler client, the memory 1222 contains instructions executable by the processor 1221, whereby the edge enabler client operates according to any step of any of the methods related to the edge enabler client as described above.

In an embodiment where the apparatus is implemented as or at the edge enabler server, the memory 1222 contains instructions executable by the processor 1221, whereby the edge enabler server operates according to any step of any of the methods related to the edge enabler server as described above.

In an embodiment where the apparatus is implemented as or at the edge application server, the memory 1222 contains instructions executable by the processor 1221, whereby the edge application server operates according to any step of the methods related to the edge application server as described above.

FIG. 13 is a block diagram showing an edge enabler client according to an embodiment of the disclosure. As shown, the edge enabler client 1300 comprises a detecting module 1302, a setting module 1304 and a sending module 1306. The detecting module 1302 may be configured to detect that application context relocation (ACR) is required. The setting module 1304 may be configured to set an information element indicating a type of service continuity in an ACR request message. The sending module 1306 may be configured to send the ACR request message to an edge enabler server.

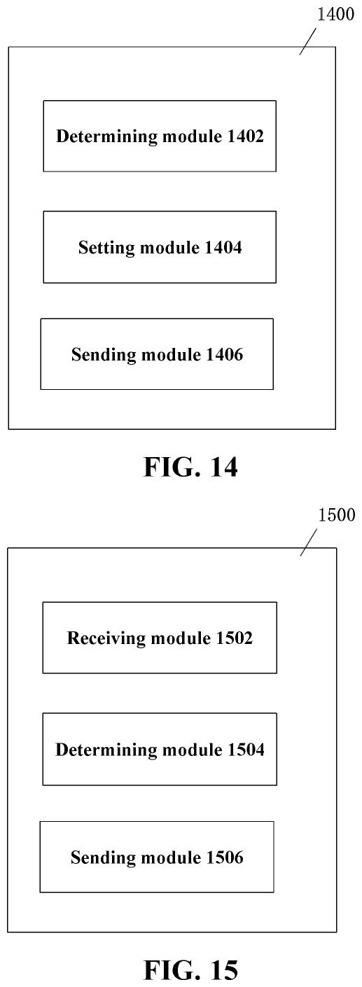

FIG. 14 is a block diagram showing an edge enabler server according to an embodiment of the disclosure. As shown, the edge enabler server 1400 comprises a determining module 1402, a setting module 1404 and a sending module 1406. The determining module 1402 may be configured to determine that application context relocation (ACR) is required. The setting module 1404 may be configured to set an information element indicating a type of service continuity in a notify message for the ACR. The sending module 1604 may be configured to send the notify message for the ACR to an edge application server.

FIG. 15 is a block diagram showing an edge application server according to an embodiment of the disclosure. As shown, the edge application server 1500 comprises a receiving module 1502, a determining module 1504 and a sending module 1506. The receiving module 1502 may be configured to receive a notify message for application context relocation (ACR) from an edge enabler server. The notify message for the ACR comprises an information element indicating a type of service continuity. The determining module 1504 may be configured to determine whether the ACR has been triggered for service continuity planning based on the information element indicating the type of service continuity. The sending module 1506 may be configured to send an ACR complete message to the edge enabler server to confirm that the ACR has completed when the ACR has been triggered for service continuity planning and after a user equipment related to the ACR moves to an expected location.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the edge enabler client, the edge enabler server and the edge application server may not need a fixed processor or memory, any computing resource and storage resource may be arranged from the edge enabler client, the edge enabler server and the edge application server in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by an edge enabler client, comprising:
detecting that application context relocation (ACR) is required;
setting an information element indicating a type of service continuity in an ACR request message; and
sending the ACR request message to an edge enabler server.

2. The method according to claim 1, wherein the edge enabler server is a source edge enabler server.

3. The method according to claim 2, wherein the ACR is executed by the edge enabler client via the source edge enabler server, or wherein the ACR is executed by the source edge enabler server.

4. (canceled)

5. The method according to claim 1, wherein the edge enabler server is a target edge enabler server.

6. The method according to claim 5, wherein the ACR is executed by the edge enabler client via the target edge enabler server.

7. The method according to claim 1, wherein when the information element indicating the type of service continuity is set in the ACR request message, the ACR request message indicates that the ACR is triggered for service continuity planning, or wherein when the information element indicating the type of service continuity is omitted in the ACR request message, the ACR request message indicates that the ACR is triggered for normal service continuity.

8. (canceled)

9. The method according to claim 1, wherein the type of service continuity comprises at least one of:
a service continuity planning, or
a normal service continuity.

10. A method performed by an edge enabler server, comprising:
determining that application context relocation (ACR) is required;
setting an information element indicating a type of service continuity in a notify message for the ACR; and
sending the notify message for the ACR to an edge application server.

11. The method according to claim 10, wherein determining that ACR is required comprises:
receiving an ACR request message comprising the information element indicating the type of service continuity from an edge enabler client; and
determining that the ACR is required based on the ACR request message comprising the information element indicating the type of service continuity.

12. The method according to claim 11, wherein when the information element indicating the type of service continuity is set in the ACR request message, the ACR request message indicates that the ACR is triggered for service continuity planning, or wherein when the information element indicating the type of service continuity is omitted in the ACR request message, the ACR request message indicates that the ACR is triggered for normal service continuity.

13. (canceled)

14. The method according to claim 10, wherein determining that ACR is required comprises:
detecting that the ACR is required; and
determining that ACR is required based on the detection.

15. The method according to claim 10, wherein the edge enabler server is a source edge enabler server and the edge application server is a source edge application server.

16. The method according to claim 15, wherein the ACR is executed by an edge enabler client via the source edge enabler server, or wherein the ACR is executed by the source edge enabler server.

17. (canceled)

18. The method according to claim 10, wherein the edge enabler server is a target edge enabler server and the edge application server is a target edge application server.

19. The method according to claim 18, wherein the ACR is executed by an edge enabler client via the target edge enabler server.

20. The method according to claim 10, wherein when the information element indicating the type of service continuity is set in the notify message for the ACR, the notify message for the ACR indicates that the ACR is triggered for service continuity planning, or wherein when the information element indicating the type of service continuity is omitted in the notify message for the ACR, the notify message for the ACR indicates that the ACR is triggered for normal service continuity.

21. (canceled)

22. The method according to claim 10, wherein the type of service continuity comprises at least one of:
a service continuity planning, or
a normal service continuity.

23-31. (canceled)

32. An edge enabler client, comprising:
a processor; and
a memory coupled to the processor, said memory containing instructions executable by said processor, whereby said edge enabler client is operative to:
detect that application context relocation (ACR) is required;
set an information element indicating a type of service continuity in an ACR request message; and
send the ACR request message to an edge enabler server.

33. (canceled)

34. An edge enabler server, comprising:
a processor; and
a memory coupled to the processor, said memory containing instructions executable by said processor, whereby said edge enabler server is operative to:
determine that application context relocation (ACR) is required;
set an information element indicating a type of service continuity in a notify message for the ACR; and
send the notify message for the ACR to an edge application server.

35-39. (canceled)
